(19) United States
(12) Patent Application Publication
(10) Pub. No.: US 2015/0212010 A1
(43) Pub. Date: Jul. 30, 2015

(54) Test Method for Optical Detection of Cup Bottom

(71) Applicant: Power Source and Associates Corp., Taipei (TW)

(72) Inventors: Tzu-Chi LIN, Taipei (TW); Hsien-Jen LIN, Taipei (TW)

(73) Assignee: Power Source and Associates Corp., Taipei (TW)

(21) Appl. No.: 14/218,617

(22) Filed: Mar. 18, 2014

(30) Foreign Application Priority Data
Jan. 27, 2014 (TW) 103102989

(51) Int. Cl. G01N 21/90; H04N 7/18; G06K 9/32; G01N 21/88; G06T 7/00

(52) U.S. Cl. CPC G01N 21/90; G01N 21/8851; G06T 7/001; G06K 9/3233; H04N 7/188; G01N 2201/062; G01N 2201/02; G06T 2207/30124; G06T 2207/10004; G06K 2207/1012; H04N 2101/00

(57) ABSTRACT

Provided is a test method for optical detection of a cup bottom, including: providing an image capturing unit, producing a reference image data, performing a cup test, and performing compliance identification. With the test method, it is practicable to perform an effective test on a cup bottom of a cup under test quickly with an image capturing unit and by means of optical testing to reject non-complying products and collect good cups, thereby ensuring the high quality of the cups thus manufactured.

### BACKGROUND OF THE INVENTION

1. Technical Field

The present invention relates to test methods for cup bottoms, and more particularly, to a test method for optical detection of a cup bottom by an image capturing unit.

2. Description of Related Art

Paper cups, especially disposable paper cups, are increasingly used in modern societies with busy lifestyles and top priority given to efficiency. Paper cups, from ones made of paper by a simple manufacturing process to delicate ones for holding hot soups, coffee, or noodle, are in wide use at any time and any place.

However, there are good as well as bad paper cups in terms of quality. When using paper cups to hold hot drinks or hot soups, users often get burnt because the bottoms of the paper cups are manufactured defectively. Defectively manufactured bottoms of paper cups will bring inconvenience to users, in case of a spill of hot drinks, cold drinks or the like otherwise contained in the paper cups.

Accordingly, it is imperative to provide an innovative test method for selecting and rejecting paper cups with non-complying cup bottoms in a simple and precise manner before delivery of paper cups, so as to effectively avoid the inconvenience and even injuries otherwise caused to users by the non-complying cup bottoms.

### SUMMARY OF THE INVENTION

The present invention provides a test method for optical detection of a cup bottom. With the test method, it is practicable to perform an effective test on a cup bottom of a cup under test quickly with an image capturing unit and by means of optical testing to reject non-complying products and collect good cups, thereby ensuring the high quality of the cups thus manufactured.

The present invention provides a test method for optical detection of a cup bottom, comprising the steps of: providing an image capturing unit; producing a reference image data, by capturing images of at least a good cup with the image capturing unit and producing a corresponding reference image data; performing a cup test, by capturing images of at least a cup under test with the image capturing unit and producing at least a corresponding test image data; and performing compliance identification, by comparing each said test image data with the reference image data, so as to identify whether the cups under test are a good cup each.

Implementation of the present invention at least involves the following inventive steps:

1. ensure that cup bottoms can be tested quickly, easily, and cheaply;

2. ensure that every paper cup delivered will have a good cup bottom with no defection; and

3. ensure that every paper cup delivered will be safe to use and will not cause inconvenience or injuries to users from damaged cup bottom.

The features and advantages of the present invention are detailed hereinafter with reference to the preferred embodiments. The detailed description is intended to enable a person skilled in the art to gain insight into the technical contents disclosed herein and implement the present invention accordingly. In particular, a person skilled in the art can easily understand the objects and advantages of the present invention by referring to the disclosure of the specification, the claims, and the accompanying drawings.

### BRIEF DESCRIPTION OF THE SEVERAL VIEWS OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a schematic view of the process flow of a test method for optical detection of a cup bottom according to an embodiment of the present invention;

FIG. 2 is a block diagram of a test module for optical detection of a cup bottom according to an embodiment of the present invention;

FIG. 3A is a schematic perspective view of a device for performing the test method according to an embodiment of the present invention;

FIG. 3B is a schematic perspective view of another device for performing the test method according to an embodiment of the present invention; and

FIG. 3C is a schematic perspective view of yet another device for performing the test method according to an embodiment of the present invention.

### DETAILED DESCRIPTION OF THE EMBODIMENT OF THE INVENTION

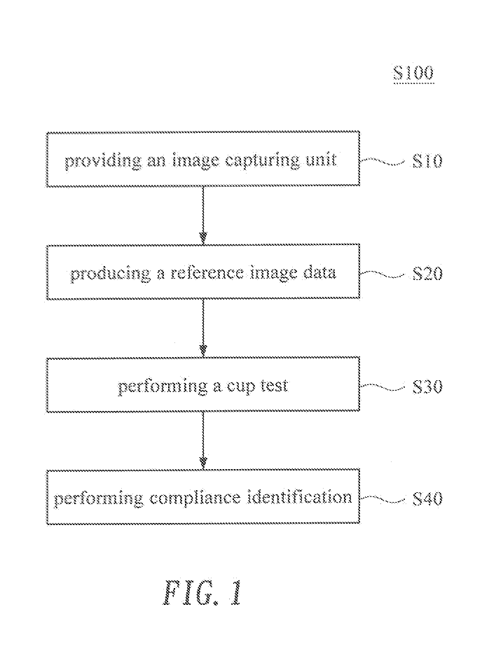

Referring to FIG. 1, in an embodiment of the present invention, a test method S100 for optical detection of a cup bottom, comprising the steps of: providing an image capturing unit (step S10); producing a reference image data (step S20); performing a cup test (step S30); and performing compliance identification (step S40).

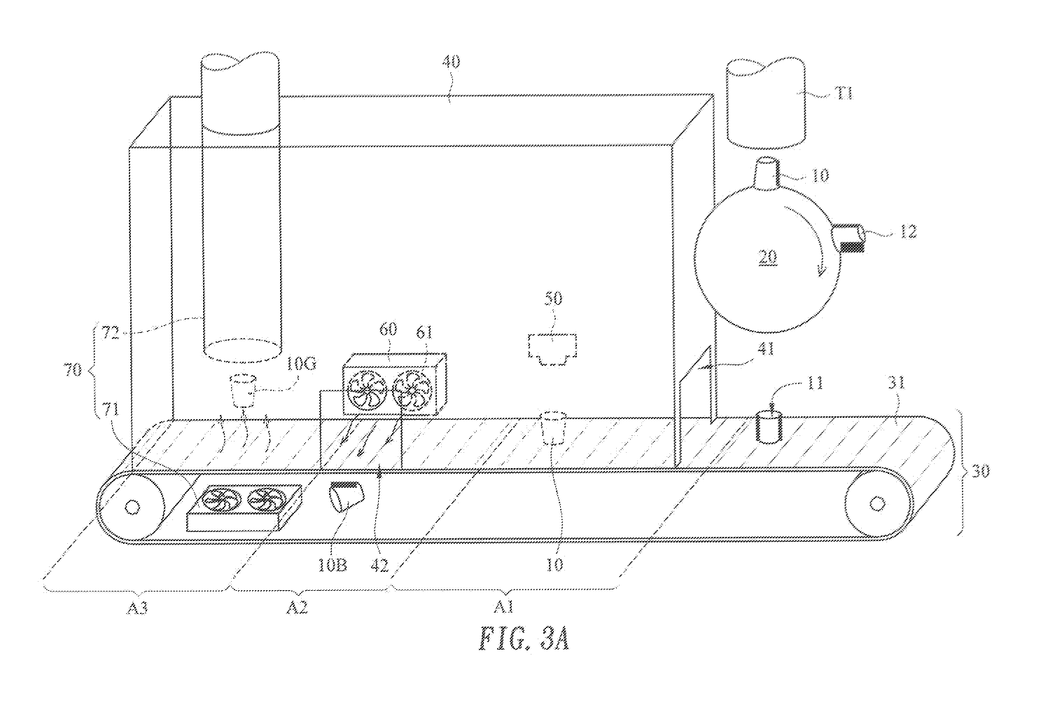

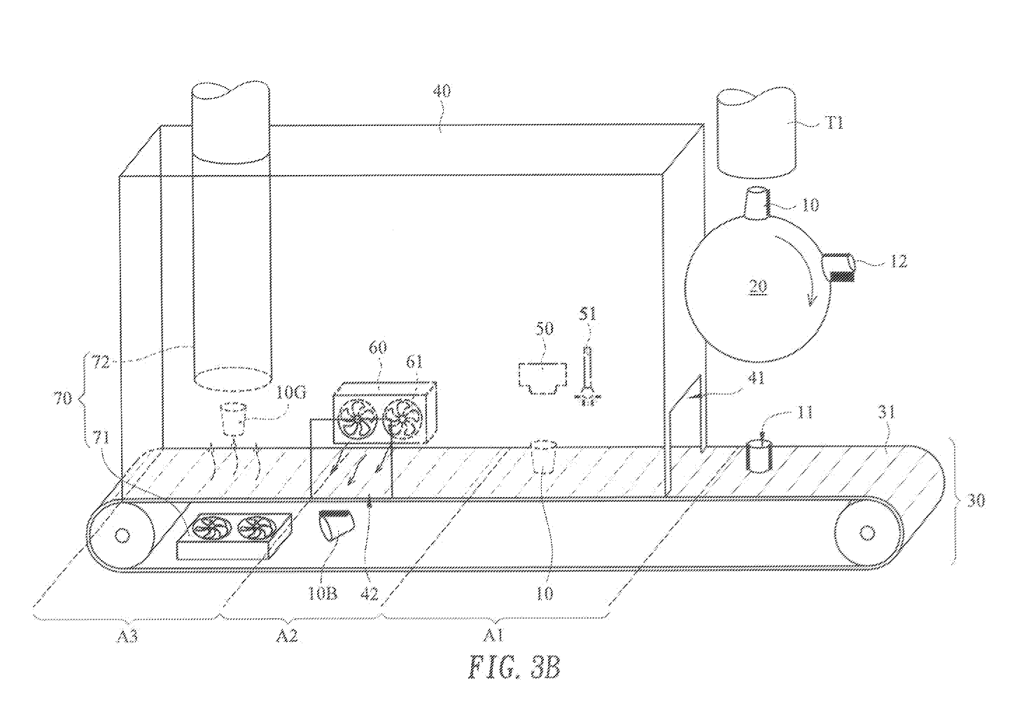

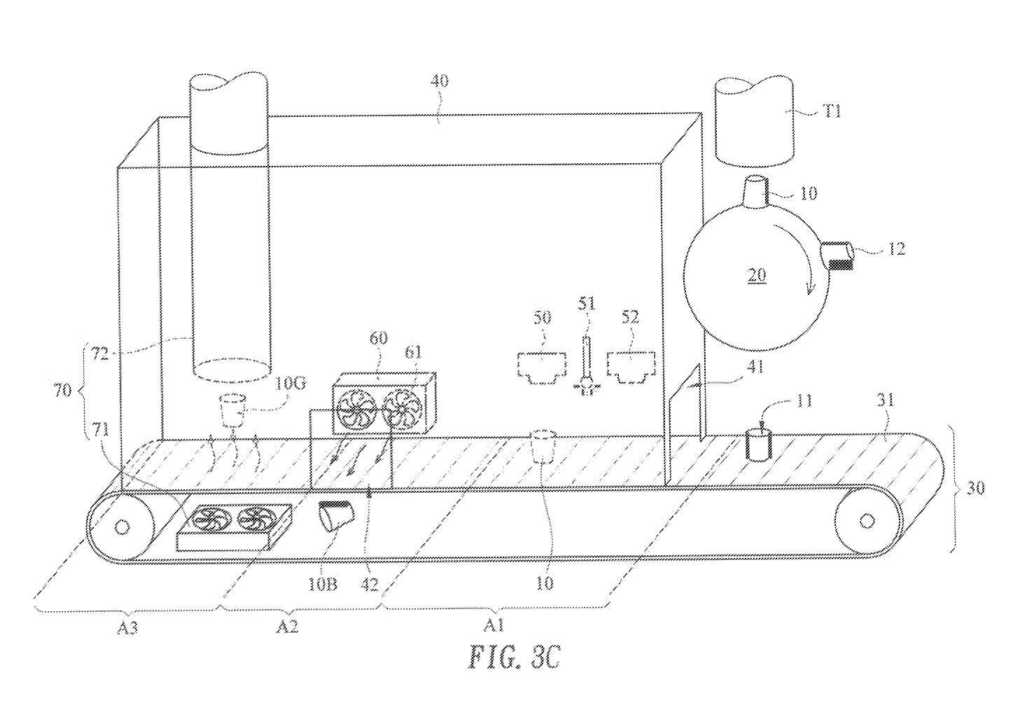

Referring to FIG. 1 and FIG. 3A through FIG. 3C, providing an image capturing unit (step S10) involves positioning an image capturing unit 50 in a test device 100 for optical detection of a cup bottom. The image capturing unit 50 captures images of a cup bottom 12 and produces a corresponding gray scale data.

Referring to FIG. 1 and FIG. 3A through FIG. 3C, producing a reference image data (step S20) involves capturing images of at least a good cup 10G by the image capturing unit 50 to produce a reference image data for use as a reference standard of comparison.

The reference image data which functions as a reference standard of comparison is produced by following the procedure: the image capturing unit 50 captures an image of the cup bottom 12 of at least one (for example, 10) good cup 10G, produces a reference image data in accordance with data pertaining to the captured image, and stores the reference image data for use as a reference standard of comparison. The reference image data is a complying gray scale data, a complying picture data, or a complying digital data produced by the image capturing unit.

To produce a bad product image data for use as a reference standard of comparison, the image capturing unit 50 captures an image of the cup bottom 12 of at least one (for example, 10) non-complying cup 10B, produces a bad product image data in accordance with data pertaining to the captured image, and stores the bad product image data for use as a reference standard of comparison. The bad product image data is a bad product gray scale data, a bad product picture data, or a bad product digital data produced by the image capturing unit.

Referring to FIG. 1 and FIG. 3A through FIG. 3C, performing a cup test (step S30) involves capturing images of at least a cup under test 10 by the image capturing unit 50 to produce at least a test image data corresponding to the captured images. The test image data is a test gray scale data, a test picture data, or a test digital data produced by the image capturing unit.

Referring to FIG. 1 and FIG. 3A through FIG. 3C, performing compliance identification (step S40) involves comparing each test image data with the reference image data, so as to identify whether each of the cups under test 10 is a good cup 10G.

In the step of performing compliance identification (step S40), the image capturing unit 50 will determine that the cup under test 10 is a good cup 10G, provided that the difference between the test image data of the cup bottom 12 of the cup under test 10 and the reference image data is not larger than ±3%.

Referring to FIG. 3A through FIG. 3C, the step of producing a reference image data (step S20), the step of performing a cup test (step S30), and the step of performing compliance identification (step S40) are performed in a box 40. In doing so, the test method of the present invention has an advantage, that is, interference of external light rays or shadows with the image capturing unit 50, which reduces the yield of the test image data and the accuracy of judgment made by the cup under test 10, is prevented.

Referring to FIG. 3B, an illuminating device 51 provides illumination while the image capturing unit 50 is capturing images of the cup bottom 12 of the cup under test 10 in the box 40, so as to increase the yield of captured images and the accuracy of the test image data produced, wherein the illuminating device 51 is an LED light source.

Referring to FIG. 3C, the image capturing unit 50 not only operates in conjunction with the illuminating device 51 which provides illumination, but also operates in conjunction with a second picture-taking module 52. The image capturing unit 50 is testing the cup bottom 12, while the second picture-taking module 52 is performing another optical test on the cup under test 10. In this regard, the other optical test is, for example, a roundness test, a noise test, or a deformation test.

Referring to FIG. 3A through FIG. 3C, the test device 100 for optical detection of a cup bottom comprises a feeding module T1, a conveying unit 20, a conveying module 30, a rejection module 60, and a collection module 70. The feeding module T1 takes at least a cup under test 10 or good cup 10G in sequence. The conveying unit 20 conveys the cup under test 10 or the good cup 10G from a cup mouth 11 to the conveying module 30. A conveyor belt 31 of the conveying module 30 conveys the cup under test 10 or the good cup 10G to test area A1, rejection area A2 or collection area A3. The rejection module 60 uses a rejection blower 61 to reject the non-complying cup 10B identified by the image capturing unit 50. The collection module 70 uses a collection blower 71 and a collection pipe 72 to collect the good cups 10G.

For example, in the aforesaid embodiment, the test method S100 for optical detection of a cup bottom further involves acquiring a test image data by capturing images of the cup bottom 12 with the image capturing unit 50, comparing the test image data and the reference image data, and determining whether the cup under test 10 is a good cup under test 10G, so as to ensure that paper cups thus manufactured are of high quality and safe to use.

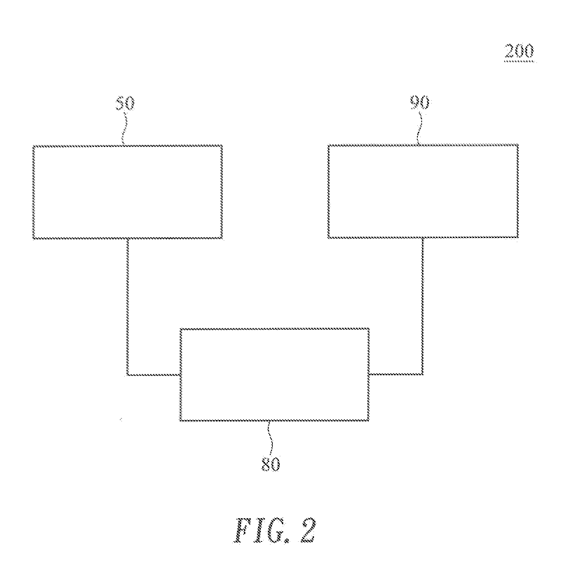

Referring to FIG. 2, in an embodiment of the present invention, a test module 200 for optical detection of a cup bottom carries out the test method S100 for optical detection of a cup bottom. The test module 200 for optical detection of a cup bottom comprises an image capturing unit 50, a processing unit 80, and a memory unit 90.

Referring to FIG. 2, the image capturing unit 50 captures images of at least a good cup 10G to produce at least a reference image data corresponding thereto or captures images of at least a cup under test 10 to produce at least a test image data corresponding thereto. The other technical features of the image capturing unit 50 are the same as those of the image capturing unit 50 in the test device 100 for optical detection of a cup bottom and thus are not described in detail herein for the sake of brevity.

Referring to FIG. 2, the processing unit 80 carries out the step of producing a reference image data, the step of performing a cup test step, and the step of performing compliance identification, controls the operation of the image capturing unit 50, and accesses the reference image data or test image data produced by the image capturing unit 50. The technical features of the step of producing a reference image data, the step of performing a cup test, and the step of performing compliance identification that are identical to the technical features of the step of producing a reference image data (step S20), the step of performing a cup test (step S30), and the step of performing compliance identification (step S40) of the test method S100 for optical detection of a cup bottom described above and thus are not described in detail herein for the sake of brevity.

Referring to FIG. 2, the memory unit 90 stores a reference image data and at least a test image data according to a command from the processing unit 80. The memory unit 90 provides the stored reference image data and test image data according to a command from the processing unit 80. The processing unit 80 performs compliance identification (step S40) on the cup under test 10, so as to determine whether the cup under test 10 is a good cup 10G.

The aforesaid reference image data is a complying gray scale data, a complying picture data, or a complying digital data produced by the image capturing unit. The test image data is a test gray scale data, a test picture data, or a test digital data produced by the image capturing unit.

The embodiments described above are intended only to demonstrate the technical concept and features of the present invention so as to enable a person skilled in the art to understand and implement the contents disclosed herein. It is understood that the disclosed embodiments are not to limit the scope of the present invention. Therefore, all equivalent changes or modifications based on the concept of the present invention should be encompassed by the appended claims.

What is claimed is:

1. A test method for optical detection of a cup bottom, comprising the steps of:
providing an image capturing unit;
producing a reference image data, by capturing images of at least a good cup with the image capturing unit and producing a corresponding reference image data;
performing a cup test, by capturing images of at least a cup under test with the image capturing unit and producing at least a corresponding test image data; and
performing compliance identification, by comparing each said test image data with the reference image data, so as to identify whether the cups under test are a good cup each.

2. The test method of claim 1, wherein the reference image data is one of a complying gray scale data, a complying picture data, and a complying digital data produced by the image capturing unit.

3. The test method of claim 1, wherein the test image data is one of a test gray scale data, a test picture data, and a test digital data produced by the image capturing unit.

4. The test method of claim 1, wherein the image capturing unit operates in conjunction with an illuminating device.

5. The test method of claim 1, wherein the image capturing unit operates in conjunction with a second picture-taking module.

6. The test method of claim 1, wherein the image capturing unit will determine that the cup is a good cup, provided that the difference between the test image data and the reference image data is not larger than ±3%.
